(19) United States
(12) Patent Application Publication
(10) Pub. No.: US 2015/0076245 A1
(43) Pub. Date: Mar. 19, 2015

(54) DEVICE FOR NEBULIZING A LIQUID

(71) Applicant: ADLYNX SARL, Mouans-sartoux (FR)

(72) Inventors: Gil Ching, Le Bar sur Loup (FR); Henri Renggli, Le Cannet (FR); Charles Pallanca, Nice (FR)

(73) Assignee: ADLYNX SARL, Mouans-sartoux (FR)

(21) Appl. No.: 14/375,691

(22) PCT Filed: Jan. 25, 2013
(86) PCT No.: PCT/FR2013/050165

§ 371 Date: Nov. 26, 2014

(30) Foreign Application Priority Data
Jan. 25, 2012 (FR) 1200210

(51) Int. Cl. B05B 17/06

(52) U.S. Cl. CPC B05B 17/0615
USPC 239/4; 239/102.2

(57) ABSTRACT

The invention relates to a device (100) for nebulizing a liquid, comprising: a vessel (110) that is open at the top portion thereof and configured so as to contain the liquid to be nebulized; at least two ultrasonic-wave generators (120, 130) for emitting at least two ultrasonic-wave fronts (122, 132) into the liquid; and at least two means (134, 124) for focusing the ultrasonic waves, each of which engages with one of said generators (120, 130) in order to concentrate ultrasonic waves at a single point P less than ten millimetres from the free surface of the liquid, wherein the vibration frequencies of the two wave fronts (122, 132) are different.

### FIELD OF THE INVENTION

This invention concerns a device for nebulizing a liquid. It particularly applies to the nebulization of water.

### PRIOR ART

The principle of acoustic nebulization is based on focusing an acoustic wave on the surface of a liquid. Several devices are used to achieve this phenomenon. The oldest is the acoustic fountain wherein the wave is oriented towards the free surface of a liquid at rest. If the acoustic intensity is sufficient, an acoustic fountain is formed, the conical shape of which focuses the ultrasonic wave. This fountain comes from the nonlinearity of acoustic propagation that transforms a small amount of vibratory energy into continuous energy (continuous flow) and forms a fountain which flows from the base upward. The acoustic wave propagates in this fountain and the acoustic concentration increases as the cross section of the fountain is reduced.

When a sufficient concentration is reached, the wall of the fountain vibrates strongly, exceeding the cavitation threshold, leading to the creation of microdroplets on the walls of the jet. Only part of the jet is nebulized, the rest of the fountain falls back into the fluid in large drops. The intensity of an acoustic wave must simply be greater than the cavitation threshold in order for nebulization to be possible.

The propagation conditions in the waveguides involve the concepts of wave number with the relationship: kᵣ²+k_{z}²=(w/C)² with
k_{z} wave number in the propagation axis in the jet,
kᵣ wave number transversal to the propagation axis in the jet,
w=2*pi*f with f being the frequency, and
C the velocity in the fluid.

It is clear that, depending on the fluids, the values of kᵣ and k_{z} are different because the velocities in the fluids vary, the limiting conditions on the walls of the jet (liquid/air interface) set the value of the number kᵣ so that, depending on the diameter of the jet, propagation of a wave or evanescent wave may occur (the wave propagates if k_{z} is a real number).

The second known principle involves focusing on the free surface of the liquid to be nebulized with a parabolic reflector (French patent application FR9205306). The advantage relative to the previous technique is being able to use a metal reflector for focusing (with high impedance rupture) rather than the fountain. Thus, the acoustic wave is focused on the free surface of the liquid, the free surface and, as in the previous case, the horizontal free surface.

Thus, the acoustic fountain which forms has a base of reduced cross-section (the concentration is greater at the base of the fountain) and, as a result, the cavitation threshold is easier to achieve. With the same energy, the flow of nebulized liquid is five to six times greater than with the conventional acoustic fountain.

The third known principle is the nose piece (French patent application FR9408204). This third principle is very similar to the hard reflector principle, but in this case, focusing takes place inside a nose piece (the reflective surface is a paraboloid, the rotation axis of which is the propagation axis of the wave to be concentrated, the focal point being located at the outlet of the nose piece).

A pump is used to propel the liquid to be nebulized through this nose piece in order to create a jet. A compression acoustic wave is sent at the base of the nose piece. As it moves forward in the nose piece, the wave is concentrated up to the nose piece outlet. The cavitation threshold is reached in the free jet leaving this nose piece and part of the jet is nebulized.

Acoustic nebulization is closely linked to the cavitation phenomenon. Several types of cavitation exist:
low cavitation, when the pressure variation required to obtain cavitation is low: this is the case of fluids containing dissolved gases and micro-impurities, and
high cavitation, obtained when the fluid is fully degassed; in this case the minimum pressure variation is much greater.

Only low cavitation is discussed within the scope of this invention. Indeed, liquids with a free surface always contain dissolved gases. When the fluid to be nebulized contains dissolved gases, the acoustic wave allows microbubbles of gas to be created. If the frequency of the acoustic wave coincides with the natural resonant frequency of the gas bubble, its diameter oscillates and becomes a source of nebulization. The nebulization flow depends on the acoustic power of the ultrasonic wave and the density of sites, known as “nuclei”, that could give rise to a bubble.

The nuclei are very dense in the fluid and the diameters of the bubbles generated are highly variable.

The smaller the nuclei, the higher the frequency which excites them. It is therefore interesting to stimulate a maximum number of nuclei to increase the nebulization flow. To achieve this, the acoustic wave that spreads must have a frequency-rich spectral component.

The yield of such devices is particularly low.

### SUMMARY OF THE INVENTION

This invention aims to remedy all or part of these drawbacks.

For this purpose, according to a first aspect, this invention relates to a device for nebulizing a liquid, comprising:

a tank, open at its upper part and configured to contain the liquid to be nebulized,

at least two ultrasonic-wave generators designed to emit at least two ultrasonic-wave fronts in the liquid,

at least two means for focusing ultrasonic waves, each cooperating with said generator for concentrating ultrasonic waves at a single concurrent point at less than ten millimeters from the free surface of the liquid,

wherein the vibration frequencies of the two wave fronts are different.

Ultrasonic waves are to be understood as sound waves with a vibration frequency above 20 kHz.

Owing to these features, the nebulization device, subject of the invention, allows two wave fronts to be focused at a single point close to the surface of the liquid. As the surface of the liquid is in contact with the air, gases are dissolved in the liquid, notably in the form of microbubbles of gas, these microbubbles being cavitation nuclei. Thus, the device of the invention allows the liquid to be subjected to a low cavitation phenomenon, i.e. if the frequency of the wave front coincides with the resonant frequency of the microbubble of gas, the diameter of the microbubble varies, thereby creating the cavitation phenomenon, and therefore allows nebulization of the liquid to take place. The smaller the diameter of a bubble, the higher the frequency required to vibrate the bubble.

The concurrent point is near the free surface of the liquid. “Near the surface” is to be understood as less than ten millimeters from the free surface of the liquid, and preferably less than five millimeters, and yet more preferably less than three millimeters.

Furthermore, as the frequencies f1 and f2 of the waves are close, and the vibration field of the liquid is located at the concurrent point, the spectrum of frequencies between f1 and f2 is scanned. Thus, the number of cavitation nuclei reached, i.e. the quantity of gas dissolved in the liquid, is increased, which unexpectedly lowers the cavitation threshold of the liquid and thus increases the yield of the device of the invention.

As a matter of fact, a gas dissolved in the liquid is present in the form of bubbles of dissolved gas. The dimensions of the gas bubbles thus vary depending on the vibrations to which they are subjected. Notably, the dimensions of the dissolved gas bubbles impose a resonance vibration.

In specific embodiments, the means for focusing ultrasonic waves consist of nose pieces configured to focus the ultrasonic waves at a single point.

In specific embodiments, the means for focusing ultrasonic waves are ultrasonic-wave reflectors of impedance rupture type, the shape of which is configured to focus the ultrasonic waves at a single point.

In specific embodiments, the means for focusing ultrasonic waves are nose pieces or ultrasonic-wave reflectors of impedance rupture type, the shape of which is configured to focus the ultrasonic waves at a single point.

In specific embodiments, the means for focusing the ultrasonic waves are cylindrical or parabolic-shaped ultrasonic wave-reflectors with impedance rupture.

In specific embodiments, at least one means for focusing ultrasonic waves is a wall containing a gas or of the silica aerogel type.

In specific embodiments, the vibration frequencies of the two wave fronts are higher than 1 MHz.

In specific embodiments, the vibration frequencies f1 and f2 of both wave fronts are such that f1 is less than f2 and the ratio (f2−f1)/(f1+f2) is less than 5%.

In specific embodiments, the vibration frequencies f1 and f2 are such that f1 is less than f2 and the ratio (f2−f1)/(f1+f2) is less than 3%.

In specific embodiments, the vibration frequencies f1 and f2 are such that f1 is less than f2 and the ratio (f2−f1)/(f1+f2) is less than 1%.

In specific embodiments, the vibration frequencies f1 and f2 are such that f2−f1 is between 10 and 30 kHz, f1 being higher than 1.5 MHz.

Owing to these features, at the concurrent point, the frequencies of the wave fronts being close, an acoustic field of similar frequencies is created, which therefore includes the frequencies f2−n*(f2−f1), where n is an integer between 0 and f2/(f2−f1). The frequency spectrum is thereby increased, along with the number of cavitation nuclei reached.

Unexpectedly, the beating created by the proximity of the waves increases locally, meaning that, at the concurrent point, the intensity of the wave fronts increases.

In specific embodiments, the ultrasonic-wave generators are ceramic or piezoelectric activators.

In specific embodiments, the wave reflectors are at the same distance from the surface of the liquid.

In specific embodiments, the device of the invention features means for measuring the height of liquid in the tank, the device comprising a means for supplying the tank with said liquid.

Owing to these features, the concurrent point remains a desired distance from the surface of the liquid.

In specific embodiments, the ultrasonic-wave reflectors are configured to vary the position of the concurrent point.

In specific embodiments, the device of the invention includes means for measuring the position of the concurrent point in the liquid, the ultrasonic-wave reflectors being configured to vary the position of the concurrent point based on said measurement.

In specific embodiments, the device of the invention further comprises means for moving the nebulized liquid beyond the surface of the tank.

In specific embodiments, the device of the invention further comprises an acoustically transparent membrane placed on the wave generators to physically separate said generators and the liquid to be nebulized.

It should be noted that the membrane may also be designed to monitor the operating temperature of the ultrasonic-wave generator.

Owing to these features, the liquid cannot deteriorate the wave generators.

In specific embodiments, the device of the invention further comprises a nozzle placed in the liquid.

Advantageously, the nozzle allows the acoustic propagation conditions to be set in the jet, as it establishes a flow diameter of the liquid to be nebulized.

In specific embodiments, the liquid is a fuel of alcohol, diesel fuel or gasoline type, or containing hydrocarbons or chemical compounds containing at least hydrogen, oxygen or carbon.

According to a second aspect, this invention relates to a method for nebulizing a liquid contained in a tank that is open at its upper part, comprising:

a step of generating at least two wave fronts in the liquid by means of ultrasonic-wave generators,

a step of focusing the wave fronts at the same concurrent point at less than ten millimeters from the surface of the liquid,

wherein the vibration frequencies of the two wave fronts are different.

In specific embodiments, the nebulization process of the invention further comprises a step of moving the nebulized liquid outside the tank.

According to a third aspect, this invention relates to a use of the device of the invention for nebulizing a liquid.

In specific embodiments, the use of the device of the invention relates to air humidification.

In specific embodiments, the use of the device of the invention relates to air cooling.

In specific embodiments, the liquid contains dissolved salts.

In specific embodiments, the use of the device of the invention relates to obtaining drinking water.

In specific embodiments, the use of the device of the invention relates to obtaining drinking water and recovering crystallized salts.

In specific embodiments, the use of the device of the invention relates to obtaining drinking water, the liquid to be nebulized being gray water or black water.

“Gray water” is to be understood as water containing pollutants from washing dishes, hands, and taking baths or showers.

“Black water” is to be understood as water comprised of a variety of substances that are more polluting or more difficult to eliminate such as as fecal matter, cosmetic products, or any type of industrial by-product mixed with water.

In specific embodiments, the use of the device of the invention relates to the fabrication of powders by the spraying of liquid containing a crystallizable product, in a controlled atmosphere.

Owing to these features, the nebulized droplets evaporate and a crystal forms. A calibrated powder is produced; the diameter dispersion of the powder is the same as the nebulized drops, i.e. 98% of the particles are the same size).

In specific embodiments, the use of the device of the invention relates to the creation of a mist, the liquid having high surface tension and low vapor tension.

In specific embodiments, the use of the device of the invention relates to the scrubbing of polluting gases.

In specific embodiments, the use of the device of the invention relates to the humidification of fabrics to improve ironing.

In specific embodiments, the use of the device of the invention relates to the creation of a fuel and oxidant mixture.

As the advantages, purposes and specific characteristics of this method and this use are similar to those of the device of this invention, they are not recalled here.

### BRIEF DESCRIPTION OF FIGURES

Other advantages, purposes and characteristics of this invention will become more apparent from the following non-limiting description when taken in conjunction with the accompanying drawings, wherein:

FIG. 1 shows a perspective view of a specific embodiment of the device according to the invention,

FIG. 2 shows the steps of a particular embodiment of the method of the present invention, in the form of a flow chart.

### DETAILED DESCRIPTION OF AN EMBODIMENT OF THE INVENTION

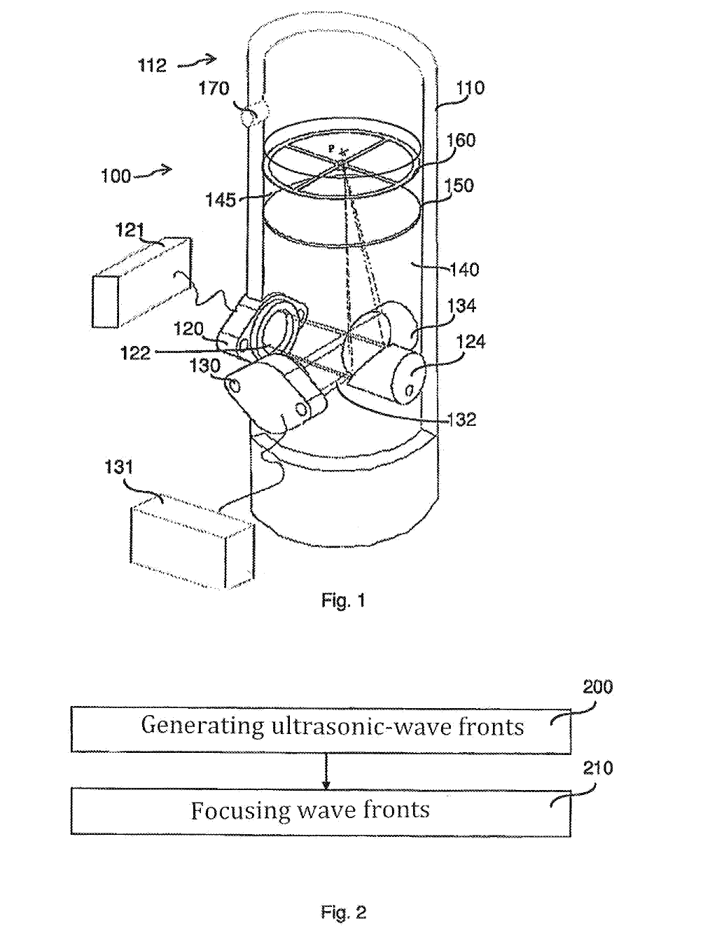

It is reminded that only weak cavitation is discussed within the scope of this invention. FIG. 1 shows a device 100 for nebulizing a liquid, comprising a tank 110 open at the top 112 and configured to contain the liquid to be nebulized. The device further comprises two ultrasonic-wave generators 120, 130 for transmitting two ultrasonic-wave fronts 122 and 132 respectively in the liquid, two means 124 and 134 respectively for focusing ultrasonic waves, each cooperating with said generator 120, 130 respectively, in order to concentrate ultrasonic waves at the same concurrent point P near the surface.

“Near” is to be understood as less than ten millimeters from the free surface of the liquid, and preferably less than five millimeters, and yet more preferably, less than three millimeters.

The flow chart shown in FIG. 2 represents a specific embodiment of the implementation method of the invention, which comprises:

a step 200 of generating at least two ultrasonic-wave fronts 122 and 132 in the liquid by means of ultrasonic-wave generators 120 and 130, and

a step 210 of focusing wave fronts 122 and 132 in a same concurrent point P near the surface of the liquid.

The liquid typically comprises water, or dissolved salts, or hydrocarbons, or chemical or organic compounds containing at least hydrogen, oxygen or carbon.

The tank 110 may also be filled with two immiscible liquids or separated into two liquid phases by an acoustically transparent membrane 150.

Thus, a lower liquid phase 140 and an upper liquid phase 145 are designated, the lower liquid phase 140 being in contact with the wave generators 120 and 130 and with the means 124 and 134 for focusing ultrasonic waves, and the upper liquid phase comprising the concurrent point P.

Typically, the lower liquid phase 140 is selected so that it does not cause wear on the wave generators and so that it is acoustically transparent. Thus, the lower liquid phase 140 is a wave propagation medium.

For example, the lower liquid phase 140 is of the incompressible gel type, the acoustic attenuation of which is less than 2 dB/cm.

Thus, the ultrasonic-wave generators 120 and 130 are protected from the air by the lower liquid phase 140.

The focusing means 124 and 134 are typically ultrasonic-wave reflectors with impedance rupture. The acoustic impedance of a body is defined as the product of its density and the velocity of sound in this body. Thus, impedance rupture is a rupture in the continuity of the impedance of two bodies in contact.

Typically, the wave reflectors 124 and 134 are selected such that their impedances are at least ten times greater than that of the liquid wherein the wave reflectors 124 and 134 are immersed.

In addition, the wave reflectors 124 and 134 are typically cylindrical or parabolic in shape, so as to concentrate the wave fronts at the concurrent point P, near the surface of the liquid.

In specific embodiments, at least one means 124 or 134 for focusing ultrasonic waves is a wall containing a gas or of silica aerogel type.

In specific embodiments, the ultrasonic-wave reflectors 124 and 134 are configured to vary the position of the concurrent point P. For example, these reflectors 124 and 134 are rotated by electric motors. Preferably, the device 100 for nebulizing a liquid comprises a means for measuring the position of the concurrent point in the liquid, the ultrasonic-wave reflectors 124 and 134 being configured to vary the position of the concurrent point based on said measurement. In some embodiments, the measurement of the position of the concurrent point P, in relation to the surface of the liquid, is a measurement of the height of liquid in the device 100. In some embodiments, the measurement of the position of the concurrent point P, in relation to the surface of the liquid, is a measurement of the quantity of nebulized liquid.

The ultrasonic-wave generators 120 and 130 are typically lead zirconium titanate type power ceramics.

It is known to those skilled in the art that the wave generators are piezoelectric activators or ceramics or monocrystal activators.

Each of the two power ceramics 120 and 130 have a specific resonant frequency, i.e. a physical variable representative of its behavior when the ceramic oscillates freely.

The power ceramics 120 and 130 are supplied power by electrical circuits (not shown) such that their natural resonant frequencies are typically between one MHz and three MHz. The electrical circuits are supplied with electricity by batteries (not shown) or by an electrical connection to the mains 121, 131 respectively.

Typically, the natural resonant frequencies f1 and f2 of the ceramics 120 and 130 are of the order of one MHz. In addition, the frequencies of the two wave fronts 122 and 132 are those of the ceramics 120 and 130, respectively.

Typically, the two ceramics are chosen such that their resonant frequencies f1 and f2 are very similar in order to lower the cavitation threshold.

Typically, power ceramics are chosen such that the frequencies f1 and f2 are different, f1 being lower than f2 and the ratio (f2−f1)/(f1+f2) being less than 5%. Preferably, power ceramics are chosen such that the ratio (f2−f1)/(f1+f2) is less than 3%. Advantageously, power ceramics are chosen such that the ratio (f2−f1)/(f1+f2) is less than 1%.

In some embodiments, the vibration frequencies f1 and f2 are such that f2−f1 is between 10 and 30 kHz, e.g. 20 kHz, preferably between 20 kHz and 30 kHz, f1 being greater than 1.5 MHz.

The reflectors 124 and 134 may be made of metal in order to have an impedance greater than that of the propagation liquid, or possibly made of a very lightweight material with low velocity, e.g. a gas, such that more than 80% of the incident wave is reflected.

The reflectors are typically spherical or parabolic in shape, such that the reflected waves are focused at point P, common and concurrent with both waves, and near the surface of the liquid.

Thus, when the two ceramic are excited, an acoustic fountain or jet is formed, followed by a cloud of droplets on the surface of the jet.

The flow rate of nebulized liquid is proportional to the pressure difference between the cavitation threshold and the pressure of the wave. The flow rate of nebulized liquid is roughly twice the reference flow rate, this reference flow rate being nebulizable by a single ceramic with its reflector.

Since both ceramics are chosen such that their resonant frequencies f1 and f2 are very close, the nebulized flow rate is greater than the sum of both reference flow rates.

As shown in FIG. 1, the device comprises ceramics and reflectors at the same distance from the surface of the liquid.

In some embodiments, the device 100 comprises an acoustically transparent membrane (not shown) placed on the wave generators 120 and 130 for physically separating said generators from the liquid to be nebulized.

It is obvious for a person skilled in the art that, based on the dimensions of the ceramics, the dimensions of the reflectors or the dimensions of the tank or the quantities of liquid to be nebulized, the device 100 may further comprise more generators and reflectors. The generators 120 and 130 and the reflectors 124 and 134 may be placed the same distance from the surface of the liquid or placed at different distances from the surface of the liquid. In addition, the device 100 may also comprise more points near the surface at which the waves are focused. Furthermore, more different frequencies can be implemented.

As shown in FIG. 1, the device 100 may comprise a nozzle 160, located between the concurrent point P and the wave generators 120 and 130.

Furthermore, the device 100 may comprise a means 170 for measuring the height of the liquid in the tank 110 and means (not shown) for supplying liquid to the tank.

This nozzle 160 is typically made of metal when the liquid is water; nozzle diameter is between two mm to ten mm.

By setting this diameter, the initial speed of the jet and the length of the jet are fixed since the nozzle 160 establishes propagation conditions for the ultrasonic-wave fronts in the jet. The nozzle 160 allows the nebulizing device 100 to be adapted to liquids that are difficult to nebulize (according to the explanation given in the prior art), particularly fluids with high surface tension and low vapor pressure.

The device 100 described is particularly suitable for the nebulization of various liquids. The aim of this nebulization is to:
vaporize these products, if vaporisable,
humidify or cool the air, notably desocking of the passenger compartment of a vehicle,
accelerate the change of state speed (liquid/vapor) of the nebulized liquid,
deodorize or scent the air by nebulizing a perfume or an active ingredient dissolved in the liquid,
prepare saturated gases,
prepare combustible product vapor for combustion and notably a combustible such as alcohol, diesel fuel or gasoline, or containing hydrocarbons, or chemical compounds containing at least hydrogen, oxygen or carbon,
if the fluid is a solution of dissolved salts, the device is particularly suitable for the separation of salts and their solvent.

The applications targeted are:
sea water desalination to recover fresh water and solid salts, the liquid containing dissolved salts,
treatment of wastewater, including “black water” or “gray water” to obtain drinking water,
fabrication of calibrated fine powder,
air humidification,
air cooling,
drinking water production,
recovery of crystallized salts,
drinking water production, the liquid to be nebulized being gray water or black water,
manufacture of powders by spraying liquid containing a crystallizable product in a controlled atmosphere,
creation of a mist, the liquid preferably having a strong surface tension and low vapor pressure,
scrubbing of gaseous pollutants,
humidification of fabrics to improve ironing, and/or
creation of a fuel and oxidizer mixture.

1-31. (canceled)

32. A device (100) for nebulizing a liquid, comprising:
a tank (110) open at its upper part and configured to contain the liquid to be nebulized,
at least two ultrasonic-wave generators (120, 130) designed to emit at least two ultrasonic-wave fronts (122, 132) in the liquid,
at least two means (134, 124) for focusing ultrasonic waves, each cooperating with said generator (120, 130) for concentrating ultrasonic waves at a single concurrent point (P) at less than ten millimeters from the free surface of the liquid,
wherein the vibration frequencies of the two wave fronts (122, 132) are different.

33. The device of claim 32, wherein the means (124, 134) for focusing ultrasonic waves are nose pieces configured to focus the ultrasonic wave at a point.

34. The device of claim 33, wherein the means (124, 134) for focusing ultrasonic waves are ultrasonic-wave reflectors of impedance rupture type, the shape of which is configured to focus the ultrasonic waves at a single point.

35. The device of claim 32, wherein the means (124, 134) for focusing the ultrasonic waves are cylindrical or parabolic-shaped ultrasonic-wave reflectors with impedance rupture.

36. The device of claim 32, wherein at least one means (124, 134) for focusing ultrasonic waves is a wall containing a gas or of silica aerogel type.

37. The device of claim 32, wherein the vibration frequencies of the two wave fronts (122, 132) are greater than 1 MHz.

38. The device of claim 32, wherein the vibration frequencies f1 and f2 of the two wave fronts (122, 132) are different, f1 being lower than f2 and the ratio (f2−f1)/(f1 f2) being less than 5%.

39. The device of claim 32, wherein the vibration frequencies f1 and f2 of the two wave fronts (122, 132) are different, f1 being lower than f2 and the ratio (f2−f1)/(f1 f2) being less than 3%.

40. The device of claim 32, wherein the vibration frequencies f1 and f2 of the two wave fronts (122, 132) are different, f1 being lower than f2 and the ratio (f2−f1)/(f1 f2) being less than 1%.

41. The device of claim 32, wherein the vibration frequencies f1 and f2 are such that f2−f1 is between 10 and 30 kHz, f1 being greater than 1.5 MHz.

42. The device of claim 32, wherein the ultrasonic-wave generators (120, 130) are ceramic or piezo-electric activators.

43. The device of claim 32, wherein the wave reflectors (124, 134) are at the same distance from the surface of the liquid.

44. The device of claim 32, which comprises a means for measuring the height of liquid in the tank, the device comprising a means for supplying the tank with said liquid.

45. The device of claim 32, wherein the ultrasonic-wave reflectors are configured to vary the position of the concurrent point.

46. The device of claim 32, further comprising a means for measuring the position of the concurrent point in the liquid, wherein the ultrasonic-wave reflectors are configured to vary the position of the concurrent point according to said measurement.

47. The device of claim 32, further comprising an acoustically transparent membrane placed on the wave generator to physically separate said generators and the liquid to be nebulized.

48. The device of claim 32, further comprising a nozzle placed in the liquid.

49. The device of claim 32, wherein the liquid is a fuel such as alcohol, diesel fuel or gasoline, or containing hydrocarbons, or chemical compounds comprising at least hydrogen, oxygen or carbon.

50. A method for nebulizing a liquid contained in a tank open at its upper part, comprising:
a step (200) of generating at least two ultrasonic-wave fronts in the liquid by means of ultrasonic-wave generators,
a step (210) of focusing the wave fronts at the same concurrent point at less than ten millimeters from the surface of the liquid,
wherein the vibration frequencies of the two wave fronts (122, 132) are different.

51. The method of claim 50, further comprising a step of moving the liquid nebulised outside the tank.
